(19) United States
(12) Patent Application Publication
(10) Pub. No.: US 2023/0183498 A1
(43) Pub. Date: Jun. 15, 2023

(54) AQUEOUS MIXTURE OF AN ALKOXYLATE AMINE AND A RHEOLOGY MODIFIER

(71) Applicant: Rohm and Haas Company, Collegeville, PA (US)

(72) Inventors: John J. Rabasco, Allentown, PA (US); Jessica R. Levin, Philadelphia, PA (US); Tara L. Conley, Chalfont, PA (US); Arnold S. Brownell, Lansdale, PA (US)

(21) Appl. No.: 18/016,879

(22) PCT Filed: Jul. 22, 2021
(86) PCT No.: PCT/US2021/042677

§ 371 Date: Jan. 19, 2023

Related U.S. Application Data
(60) Provisional application No. 63/062,110, filed on Aug. 6, 2020.

(51) Int. Cl. C09D 7/44; C09D 7/63; C09D 7/65

(52) U.S. Cl. CPC C09D 7/44; C09D 7/63; C09D 7/65

(57) ABSTRACT

The present invention relates to a composition comprising an aqueous mixture of a rheology modifier and a surfactant of Formula I:

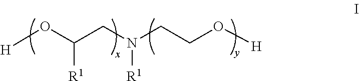

where R, R¹, x, and y are as defined herein. The composition of the present invention provides a rheology modifier that does not promote microbial growth and does not require a biocide.

### BACKGROUND OF THE INVENTION

The present invention relates to a composition comprising an aqueous mixture of an alkoxylate amine and a rheology modifier. The composition of the present invention is useful in paint formulations.

Biocides are typically added to low volatile organic content (low VOC) coatings formulations and waterborne raw materials used in these formulations to maintain product quality and avoid spoilage caused by microbial growth. Inasmuch as low VOC formulations are more susceptible to spoilage by microbial growth than solvent-borne and higher VOC waterborne paints, the coatings industry has increasingly relied on biocides, chiefly isothiazolinone-based biocides, to protect these low VOC water-borne formulations against microbial growth.

The European Biocidal Product Review (BPR) is endeavoring to reduce the maximum allowed level of 2-methyl-4-isothiazolin-3-one (MIT) in consumer products including coatings formulations to 15 ppm, a level below MIT's efficacy. The anticipation of more stringent regulations on biocide use in products worldwide along with rising customer and consumer concerns with using sensitizing biocides like MIT or carcinogen, mutagen, and reproductive toxin (CMR) biocides like formaldehyde and zinc pyrithione, coatings and raw materials formulators are left with few biocidal options that are deemed safe and efficacious.

An example of waterborne raw materials that are used in low VOC waterborne coatings formulations is a rheology modifier, which disadvantageously require biocides. It would therefore be an advantage in the art of coatings formulations to discover a way to provide a biocide free rheology modifier that is inherently resistant to microbial growth.

### SUMMARY OF THE INVENTION

The present invention addresses a need in the art by providing a composition comprising an aqueous mixture of a rheology modifier and a surfactant of Formula I:

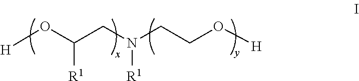

wherein each R is independently H, methyl, or ethyl;

R¹═—R²—NR³—(CH₂CH₂O)_{z}—H; or —C₆-C₁₈; or —C(CH₃)₂R₄;

x is from 1 to 40; y is from 0 to 39; and z is from 0 to 39;

with the proviso that when y is 0, R¹ is —C(CH₃)₂R⁴; and when y is from 1 to 39, R¹ is —R²—NR³—(CH₂CH₂O)_{y}—H or —C₆-C₁₈;

R² is —CH₂CH₂CH₂— or —CH(CH₃)CH₂— or —CH₂CH(CH₃)—;

R³ is saturated or partially unsaturated C₁₀-C₂₂-alkyl;

R⁴ is C₁-C₂₀-alkyl;

x+y+z=1 to 40;

wherein the weight-to-weight ratio of the rheology modifier to the surfactant of Formula I is in the range of from 1:2 to 100:1. The composition of the present invention provides a rheology modifier that does not promote microbial growth and does not require a biocide.

### DETAILED DESCRIPTION OF THE INVENTION

The present invention is a composition comprising an aqueous mixture of a rheology modifier and a surfactant of Formula I:

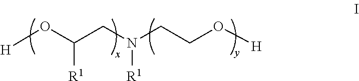

wherein each R is independently H, methyl, or ethyl;

R¹═—R²—NR³—(CH₂CH₂O)_{z}—H; or —C₆-C₁₈; or —C(CH₃)₂R₄;

x is from 1 to 40; y is from 0 to 39; and z is from 0 to 39;

with the proviso that when y is 0, R¹ is —C(CH₃)₂R⁴; and when y is from 1 to 39, R¹ is —R²—NR³—(CH₂CH₂O)_{y}—H or —C₆-C₁₈;

R² is —CH₂CH₂CH₂— or —CH(CH₃)CH₂— or —CH₂CH(CH₃)—;

R³ is saturated or partially unsaturated C₁₀-C₂₂-alkyl;

R⁴ is C₁-C₂₀-alkyl;

x+y+z=1 to 40;

wherein the weight-to-weight ratio of the rheology modifier to the surfactant of Formula I is in the range of from 1:2 to 100:1.

Examples of rheology modifiers include hydrophobically modified alkylene oxide polymers, hydroxyethyl cellulose (HEC), hydroxymethylethyl cellulose (HMEC), hydrophobically modified hydroxyethyl cellulose (HMHEC), hydrophobically modified alkali soluble emulsion (HASEs), hydrophobically modified polyether (HMPE), hydrophobically modified aminoplast ethers (HEATs), hydrophobically modified polyacrylamides.

Preferably, the rheology modifier is one or more hydrophobically modified alkylene oxide polymers. As used herein, “alkylene oxide polymer” refers to water-soluble polyethylene oxide polymers, as well as water-soluble polyethylene oxide/polypropylene oxide and polyethylene oxide/polybutylene oxide copolymers. Preferably, the alkylene oxide polymer is an alkylene oxide urethane polymer, more preferably an ethylene oxide urethane polymer.

The hydrophobically modified alkylene oxide polymer is conveniently prepared by contacting under suitable reactive conditions, a) a water-soluble polyalkylene glycol; b) a stoichiometric excess of a diisocyanate relative to the polyalkylene glycol; and c) a hydrophobic compound to form the hydrophobically modified alkylene oxide urethane polymer. Component b) may also be dichloromethane, dibromomethane, epichlorohydrin, or an aminoplast instead of a diisocyanate.

When component a) is a polyethylene glycol, and b) is a diisocyanate, the resulting hydrophobically modified alkylene oxide polymer is a hydrophobically modified ethylene oxide urethane polymer (HEUR).

Preferred water-soluble polyalkylene oxides are polyethylene glycols, particularly polyethylene glycols having a weight average molecular weight in the range of from 600 to 12,000 Daltons. An example of a suitable polyethylene glycol is PEG 8000, which is commercially available as CARBOWAX™ 8000 Polyethylene Glycol (PEG-8000, a trademark of The Dow Chemical Company (“Dow”) or an affiliate of Dow, Midland, Mich.).

Examples of suitable diisocyanates include 1,4-tetramethylene diisocyanate, 1,6-hexamethylene diisocyanate (HDI), 2,2,4-trimethyl-1,6-diisocyanatohexane, 1,10-decamethylene diisocyanate, 4,4′-methylenebis(isocyanatocyclohexane) (H₁₂-MDI), 2,4′-methylenebis(isocyanatocyclohexane), 1,4-cyclohexylene diisocyanate, 1-isocyanato-3-isocyanatomethyl-3,5,5-trimethylcyclohexane (IPDI), m- and p-phenylene diisocyanate, 2,6- and 2,4-toluene diisocyanate (TDI), xylene diisocyanate, 4-chloro-1,3-phenylene diisocyanate, 4,4′-methylene diphenyl diisocyanate (MDI), 1,5-naphthylene diisocyanate, and 1,5-tetrahydronaphthylene diisocyanate. Examples of commercially available diisocyanates are Desmodur W cycloaliphatic diisocyanate (DesW) and Desmodur H (HDI).

The hydrophobic compound is typically a linear, branched, or cyclic C₆-C₂₄ alkyl, aryl, or aralkyl compound functionalized with a hydroxyl group, an amine group, or both. Examples of suitable hydrophobic compounds include n-hexanol, n-octanol, 2-butyl-1-octanol, n-decanol, n-dodecanol, n-hexadecanol, cyclohexanol, C₁-C₆-alkyl cyclohexanols, n-octylamine, n-decylamine, n-dodecylamine, 1,6-hexanediol, 1,8-octanediol, 1,12-dodecanediol, 1,2-hexanediol, 1,2-octanediol, 1,2-dodecanediol, and hydrophobic aminoalcohols, including bis(2-ethylhexyl)aminoethanol, and dibenzylaminoethanol.

When y is 0, the surfactant of Formula I is illustrated by Formula Ia:

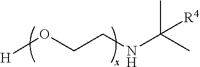

where R⁴ is preferably C₆-C₁₄-alkyl, and x=2 to 30. Examples of commercial surfactants within the scope of Formula Ia include TRITON™ RW-20 (RW-20, x=2, R⁴=decyl), TRITON™ RW-50 (RW-50, x=5, R⁴=decyl), and TRITON™ RW-150 (RW-150, x=15, R⁴=decyl) Surfactants. (TRITON is a Trademark of The Dow Chemical Company or its Affiliates) Another subgenus of the surfactant of Formula I is illustrated by Formula Ib:

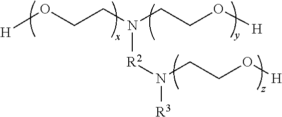

where R³ is preferably saturated or partially saturated C₁₄-C₂₀-alkyl, more preferably saturated or partially saturated C₁₆—Cis-alkyl, and x+y+z=2 to 32. As used herein, “partially unsaturated” refers to the presence of one or two double bond within the alkyl chain. Examples of commercial surfactants within the scope of Formula Ib include Ethox DT-15 (DT-15, x+y+z=15); and Ethox DT-30 (DT-30, x+y+z=30) Tallow diamines.

Yet another subgenus of the surfactant of Formula I is illustrated by Formula Ic:

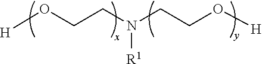

where R¹ is preferably C₁₂-C₁₈-alkyl, and x+y=12 to 18. An example of a commercial surfactant within the scope of Formula Ic is Ethox CAM-15 Cocoamine (CAM-15, x+y=15).

The weight-to-weight ratio of the rheology modifier to the surfactant of Formula I is preferably in the range of from 1:1, more preferably from 5:1, more preferably from 10:1, and most preferably from 20:1, to 50:1, more preferably to 30:1.

The viscosity of the composition is preferably in the range of from 500 to less than 22,000 centipoise (cP), more preferably to less than 15,000 cP, and most to less than 10,000 cP. Acid may be added to the composition to reduce the viscosity of the rheology modifier. Accordingly, the composition may additionally include from 0.1 to 5 weight percent of an acid or a salt thereof.

The composition is useful as a thickener for coatings formulations, more particularly paint formulations. Accordingly, in another aspect the composition includes one or more materials such as binders, coalescents, surfactants, dispersants, defoamers, opacifying pigments such as TiO₂ and organic opaque polymer particles, colorants, and neutralizing agents.

### EXAMPLES

### Intermediate Example 1—Preparation of a HEUR Rheology Modifier (RM1)

PEG-8000 (1711.9 g) was heated to 110° C. in vacuo in a batch melt reactor for 2 h, after which time butylated hydroxytoluene (BHT, 0.182 g) and n-hexanol (18.91 g) were added to the reactor. The reaction mixture was stirred for 5 min, whereupon H₁₂-MDI (77.85 g) was added to the reactor with continued stirring for an additional 5 min. Bismuth octoate (28% Bi, 4.28 g) was then added to the reactor and the resulting mixture was stirred for 10 min at 110° C. n-Hexanol (3.26 g) was then added to the reactor and mixing was continued for another 10 min at 110° C. The resulting molten polymer was removed from the reactor and cooled. This solid polymer was then dissolved in water to form a solution containing 20 wt % polymer (RM1) with surfactant and phosphoric acid as shown in Table 2.

### Intermediate Example 2—Preparation of a HEUR Rheology Modifier (RM2)

PEG-8000 (1854.8 g) and Lumulse POE (26) glycerine (46.60 g) were heated in vacuo to 110° C. in a batch melt reactor for 2 h. After cooling the reactor contents to 85° C., butylated hydroxyl toluene (BHT, 0.202 g), 2-butyl-1-octanol (47.81 g), and HDI (63.41 g) were added sequentially to the reactor with mixing for 5 min. Bismuth octoate (28% Bi, 4.64 g) was then added to the reactor and the temperature of the mixture was maintained at 85° C. with stirring for 20 min. The resulting molten polymer was removed from the reactor and cooled. This solid polymer was then dissolved in water to form a solution containing 17 wt % polymer (RM2) with surfactant and phosphoric acid as shown in Table 2.

### Intermediate Example 3—Preparation of a HEUR Rheology Modifier (RM3)

PEG-8000 (1700.0 g) was heated to 110° C. in vacuo in a batch melt reactor for 2 h. After cooling the reactor contents to 90° C., butylated hydroxytoluene (BHT, 0.18 g) and n-decanol (15.3 g) were added to the reactor with stirring for 5 min. H₁₂MDI (94.6 g) was then added to the reactor and stirring was continued for 5 min. Bismuth octoate (28% Bi, 4.25 g) was then added to the reactor, and the resulting mixture was stirred for an additional 10 min at 90° C. n-Decanol (48.1 g) was then added to the reactor and mixing was continued for 10 min at 90° C. The resulting molten polymer was removed from the reactor and cooled. This solid polymer was then dissolved in water to form a solution containing 17.0 wt % polymer (RM3) with surfactant and phosphoric acid as shown in Table 2.

Preparation of Samples for Microbial Resistance

Samples were inoculated 2 times at 7-d intervals with 10⁶-10⁷ colony forming units per milliliter of sample (CFU/mL) of a standard pool of bacteria, yeasts, and molds obtained from American Type Culture Collection (ATCC) that are common contaminants in coatings. Once inoculated, the samples were stored in 25° C. incubators. Test samples were monitored for microbial contamination by agar plating using a standard streak plate method. Samples were plated 1 and 7 day after each microbial challenge onto trypticase soy agar (TSA) and potato dextrose agar (PDA) plates. All agar plates were checked daily up to 7 d after plating to determine the number of microorganisms surviving in the test samples. When not being checked, the agar plates were stored in incubators, 30° C. for TSA plates and 25° C. for PDA plates. The extent of microbial contamination was established by counting the colonies, where the rating score was determined from the number of microbial colonies observed on the agar plates. Reported results come from day 7 readings. Results are described by the rating score for each type of microorganism: B=bacteria, Y=yeast, and M=mold. For example, a 3B describes a plate with 3 rating score for bacteria, or a Tr Y(1) describes a plate with trace yeast (1 colony on plate). Table 1 illustrates the rating system used to estimate the level of microbial contamination on streak plates. Colonies refers to the number of colonies on the plate.

TABLE 1
Rating system for estimating microbial contamination

| | Rating | | |
|---|---|---|---|
| Colonies | Score | Contamination | Result |
| None | 0 | None | Pass |
| 1-9 | Tr | Trace | Pass |
| 10 to 99 | 1 | Very Light | Fail |
| 100 to ~1000 | 2 | Light | Fail |
| ~1000 to 10,000 | 3 | Moderate | Fail |
| >10,000 | 4 | Heavy | Fail |

As-is Viscosity Measurements

As-is viscosities of the rheology modifier samples were measured on a Brookfield viscometer using spindle 4 at 60 RPM.

Table 2 illustrates the pH and viscosities of the compositions containing HEURs with and without surfactants of Formula I. Each sample contained 0.9 weight percent phosphoric acid. All weights are based on the weight of water, the HEUR, the surfactant, and phosphoric acid. Comparative Example 2 included 4.2% methyl-β-cyclodextrin to suppress viscosity.

TABLE 2
pH and Viscosity of HEUR Surfactant Samples

| | | | | Surfactant | Viscosity | |
|---|---|---|---|---|---|---|
| Ex. No. | Surfactant | HEUR % | HEUR | Con. | (cP) | pH |
| 1 | DT-15 | 20 | RM1 | 1% | 4790 | 2 |
| 2 | CAM-15 | 17 | RM2 | 15% | 12500 | 7 |
| 3 | DT-30 | 17 | RM2 | 10% | 21400 | 5.9 |
| 4 | RW-20 | 20 | RM1 | 1% | 3870 | 2.3 |
| 5a | RW-50 | 20 | RM1 | 2% | 2990 | 2.8 |
| 5b | RW-50 | 17 | RM2 | 5% | 15800 | 6.1 |
| 5c | RW-50 | 17 | RM3 | 10% | 4910 | 6.9 |
| 6a | RW-15 | 20 | RM1 | 10% | 2570 | 6.7 |
| 6b | RW-15 | 17 | RM2 | 15% | 7830 | 7.1 |
| Comp 1 | none | 17 | RM3 | 0 | <5000 | 1.9 |
| Comp 2 | none | 20 | RM1 | 0 | <5000 | 1.8 |

Table 3 illustrates the results of the challenge tests for each sample.

TABLE 3
Results of Challenge Tests for HEURs
with and without Surfactant

| Example No. | Challenge 1 | Challenge 2 | Challenge 3 |
|---|---|---|---|
| 1 | Pass | Pass | Pass |
| 2 | Pass | Pass | Pass |
| 3 | Pass | Pass | Pass (Tr M(1)) |
| 4 | Pass (Tr M(1)) | Pass (Tr M(2)) | Pass (Tr M(3)) |
| 5a | Pass (Tr M(1)) | Pass | Pass |
| 5b | Pass | Pass | Pass |
| 5c | Pass | Pass | Pass |
| 6a | 1Y* | Pass | Pass |
| 6b | Pass | Pass | Pass |
| Comp. 1 | 2M | 1M | Fail |
| Comp. 2 | 2M | Tr Y(1) 3M | Fail |

The data show that admixtures of a variety of rheology modifiers and surfactants of Formula I do not support microbial growth in challenge tests. The surfactant also reduces the viscosity of the rheology modifier solution, thereby providing manufacturers greater ease of delivering pourable aqueous solutions. Since the biocide addition is not needed to maintain product quality, formulation complexity can be reduced and potential health and environmental hazards attributed to biocide addition can be eliminated.

1. A composition comprising an aqueous mixture of a rheology modifier and a surfactant of Formula I: 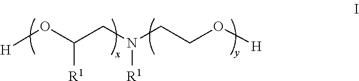
wherein each R is independently H, methyl, or ethyl;
R¹═—R²—NR³—(CH₂CH₂O)_{z}—H; or —C₆-C₁₈; or —C(CH₃)₂R₄;
x is from 1 to 40; y is from 0 to 39; and z is from 0 to 39;
with the proviso that when y is 0, R¹ is —C(CH₃)₂R⁴; and when y is from 1 to 39, R¹ is —R²—NR³—(CH₂CH₂O)_{y}—H or —C₆-C₁₈;
R² is —CH₂CH₂CH₂— or —CH(CH₃)CH₂— or —CH₂CH(CH₃)—;
R³ is saturated or partially unsaturated C₁₀-C₂₂-alkyl;
R⁴ is C₁-C₂₀-alkyl;
x+y+z=1 to 40;
wherein the weight-to-weight ratio of the rheology modifier to the surfactant of Formula I is in the range of from 1:2 to 100:1.

2. The composition of claim 1 wherein each R is H, and the rheology modifier is an alkylene oxide polymer.

3. The composition of claim 2 wherein the rheology modifier is an ethylene oxide urethane polymer, wherein the weight-to-weight ratio of the ethylene oxide urethane polymer to the surfactant of Formula I is in the range of from 1:1 to 30:1.

4. The composition of claim 3 wherein the surfactant of Formula I is represented by Formula Ia: 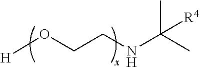
where R⁴ is C₆-C₁₄-alkyl; and x=2 to 30.

5. The composition of claim 3 wherein the surfactant of Formula I is represented by Formula Ib: 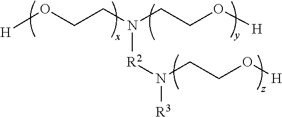
where R³ is saturated or partially saturated C₁₄-C₂₀-alkyl; and x+y+z=2 to 32.

6. The composition of claim 3 wherein the surfactant of Formula I is represented by Formula Ic: 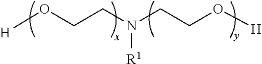
where R¹ is C₁₂-C₁₈-alkyl; and x+y=12 to 18.

7. The composition of claim 3 which comprises an absence of a biocide.

8. The composition of claim 1 which further includes one or more materials selected from the group consisting of binders, coalescents, surfactants, dispersants, defoamers, opacifying pigments, and colorants.
